(19) United States
(12) Patent Application Publication
(10) Pub. No.: US 2012/0210215 A1
(43) Pub. Date: Aug. 16, 2012

(54) METHOD AND APPARATUS FOR PROVIDING NETWORKED ASSISTANCE AND FEEDBACK CONTROL FOR CONSUMER ELECTRONIC DEVICES

(75) Inventor: Michael Patrick Chrabaszcz, Milpitas, CA (US)

(73) Assignee: Rovi Technologies Corporation, Santa Clara, CA (US)

(21) Appl. No.: 13/028,420

(22) Filed: Feb. 16, 2011

(51) Int. Cl. G06F 3/01

(52) U.S. Cl. 715/708

(57) ABSTRACT

A computer-implemented method, system, and apparatus for providing networked assistance and feedback control for consumer electronic devices are disclosed. The system and method in an example embodiment include: gathering user behavior and feedback information collected on a user platform via a data network; processing the user behavior and feedback information, by using a processor, to infer a problem encountered by a user on the user platform in operating a consumer electronic (CE) device of the user platform; activating a user interface on the user platform to offer the user assistance in resolving the problem; and recording the problem as a design hint related to a potential design change corresponding to the CE device.

### COPYRIGHT NOTICE

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2008-2011, Macrovision Solutions Corporation and Rovi Corporation, All Rights Reserved.

### BACKGROUND

1. Technical Field

This disclosure relates to networked systems. More particularly, the present disclosure relates to networked consumer electronic devices.

2. Related Art

In conventional consumer electronic (CE) device systems, it can be difficult for users to properly configure and use a complicated CE device. Although modern CE devices have a high degree of functionality related to the rendering of entertainment content for which the CE device was designed, these devices are typically controlled with a user interface usually comprising clusters of buttons and indicators on a front panel or remote control unit of the CE device. These typical CE device user interfaces can be daunting for users to understand and may create a poor overall user experience. Additionally, CE device designers cannot get real-time access to information describing problems user's are having with their CE devices.

U.S. Pat. No. 5,977,964 describes a method and apparatus for automatically configuring a system based on a user's monitored system interaction and preferred system access times and updating a user profile corresponding to the user based at least in part on the monitored user interaction with the system. Preferred system access times of the user are identified based at least in part on the user profile, and the system is automatically configured based at least in part on the user profile and the user's preferred system access times.

Thus, a computer-implemented system and method for providing networked assistance and feedback control for consumer electronic devices is needed.

### BRIEF DESCRIPTION OF THE DRAWINGS

Embodiments are illustrated by way of example and not limitation in the figures of the accompanying drawings, in which:

FIG. 1 illustrates an example networked system architecture for providing consumer electronic device support for a user of a user platform, according to various embodiments;

FIG. 2 illustrates an example user platform, which may correspond to the user platform shown in FIG. 1;

FIG. 3 illustrates a detail of the example networked system architecture for providing consumer electronic device support for a user of a user platform, according to various embodiments;

FIG. 4 illustrates a sequence of processing operations in an example embodiment; and

FIG. 5 shows a diagrammatic representation of a machine in the form of a computer system within which a set of instructions, for causing the machine to perform any one or more of the methodologies discussed herein, may be executed, according to an example embodiment.

### DETAILED DESCRIPTION

A computer-implemented method, system, and apparatus for providing networked assistance and feedback control for consumer electronic devices are disclosed. In the following description, numerous specific details are set forth. However, it is understood that embodiments may be practiced without these specific details. In other instances, well-known processes, structures and techniques have not been shown in detail in order not to obscure the clarity of this description. Various embodiments are described below in connection with the figures provided herein.

### Overview of Various Embodiments

The various embodiments described herein are part of a networked system including a consumer electronic (CE) device, networked consumer entertainment system, or set-top box, generally denoted herein as CE devices. In various example embodiments, these CE devices may include a television/monitor, set-top box, cable box, satellite receiver, video recorder/playback device, DVD recorder/playback device (DVD is currently used as an acronym for digital video disk and also digital versatile disk to reflect the ability of DVD technology to be used for data other than video, DVD can include Blu-Ray), audio/video tuner and amplifier, audio playback/recorder device, compact disk (CD) player, digital media player, game consoles, and other forms of consumer entertainment devices. In one embodiment, any of these CE devices, as part of a user platform, can be coupled to a wired or wireless network interface to enable the user platform, and the CE device(s) therein, to transmit and receive data via a wide area network, such as the Internet.

As described for example embodiments, a CE device can have an active internet connection that allows a central host or service provider (presumably the CE device manufacturer or designer) to continually monitor user behavior (keystrokes, views, clicks, etc.) to determine if the user is efficiently able to install, program, configure, use, and interact with the CE device. The CE device can capture user data and system data for upload to the host. The host can run an analysis or diagnostic process on the uploaded data to: offer help to the user, use the data to create/modify product requirement specifications for the CE device in response to the user experience, or organize and control a feedback mechanism to conduct surveys or focus groups in regard to the operation or improvement of the design of the CE device.

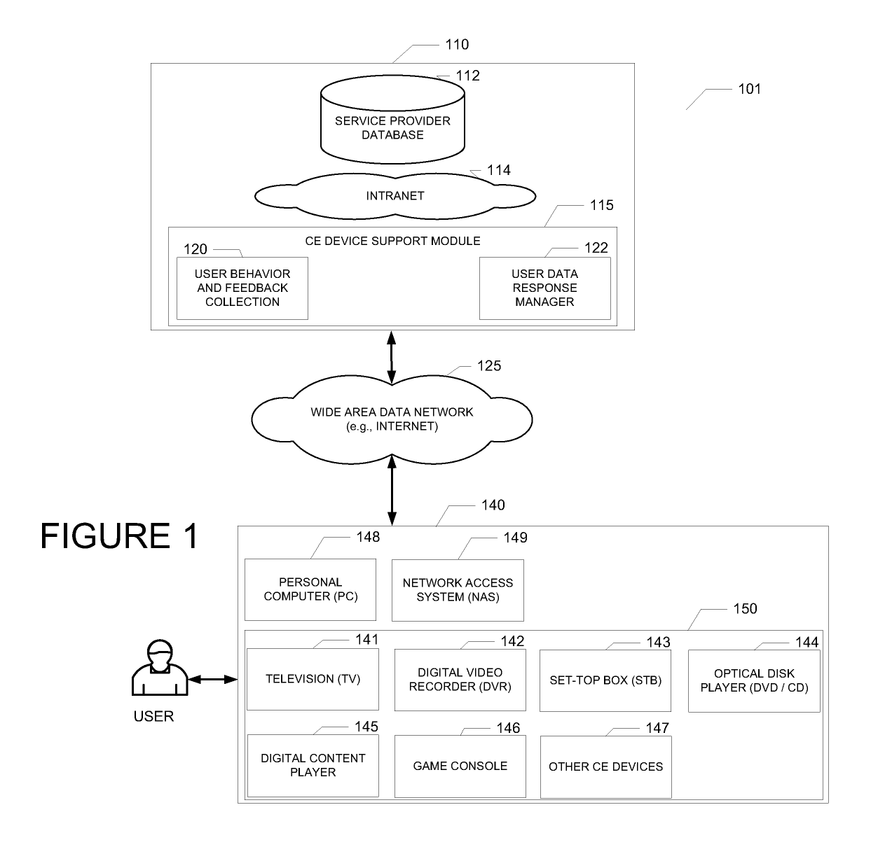

Referring now to FIG. 1, a networked system 101 of an example embodiment is illustrated. In the example system embodiment 101, a host or service provider 110 is in data network communication with a user platform 140 via a wide area data network 125, such as the Internet. The host 110 can include a server computer, which can execute a CE device support module 115. In the example embodiment shown in FIG. 1, the host 110 may also comprise a service provider database 112, such as a user and CE device information database coupled via an intranet 114 to the CE device support module 115. The CE device support module 115 can be implemented as a server application or a service oriented architecture (SOA) service. In general, the CE device support module 115 provides functionality to monitor user behavior, to offer help to the user, process the user data to create/modify product requirement specifications for the CE device in response to the user experience, and organize and control a feedback mechanism to conduct surveys or focus groups in regard to the operation or improvement of the CE device. The CE device support module 115 of an example embodiment includes at least two functional components: a user behavior and feedback collection module 120, and a user data response manager 122. The user behavior and feedback collection module 120 gathers and stores user behavior data indicative of user interactions with a CE device on the user platform 140. The user behavior data can include CE device remote control button activations, CE device menu selections, mouse click events, mouseover events, webpage access and/or view events, content access and/or view events, object selection events, purchase or bid events, and the like. The user behavior and feedback collection module 120 can also coordinate the collection and storage of user feedback data regarding user responses to technical questions asked by a technician, responses to requests for feedback, responses to user surveys, and the like. This user behavior data and user feedback data can be sent to the user behavior and feedback collection module 120 by the user platform 140 via the network 125.

The user data response manager 122 of the host 110 handles the processing of the user behavior data and the user feedback data collected by the user behavior and feedback collection module 120. In general, the user data response manager 122 can analyze the user behavior data to determine if the user behavior with regard to a particular CE device is consistent with appropriate or normal use of the CE device. For example, the user data response manager 122 can monitor a series of CE device remote control button activations by a user to determine if the user appears to be experiencing problems in using the CE device. For example, a series of repeated attempts to perform a CE device function may indicate an operational problem. Additionally, the user data response manager 122 can analyze a series of CE device remote control button activations by a user to determine how the user typically uses the CE device. For example, it may be determined that a typical user usually navigates through a menu of command options to activate a particular function even though the CE device provides a shortcut activation of the same function. This may indicate an opportunity for the CE device designer to re-design the user interface of the CE device to make its functionality more accessible to the user. The user data response manager 122 can infer a large amount of information about the user's interaction with the CE device from the collected user behavior data. Additionally, the user data response manager 122 can analyze the user feedback data to further infer additional information about the user's interaction with the CE device from the collected user feedback data. As described in more detail below, this information can be used to both offer help to the user in using the CE device efficiently and offer analysis information for CE device designers to create/modify product requirement specifications for the CE device in response to the user experience.

Referring again to FIG. 1, the networked system 101 of an example embodiment includes a user platform 140 in data network communication with the host 110 via a wide area data network 125. A user platform, e.g., a user device or a set of user devices, may comprise one or more of a variety of consumer electronic (CE) devices including additional hardware and software that enables the consumer electronic device to register with the host 110. As shown in FIG. 1, the CE devices 150 of the user platform 140 may include a television 141, a digital video recorder (DVR) or personal video recorder (PVR) 142, a set-top box (STB) 143, an optical disk player (e.g., a DVD or CD player) 144, a digital content player (e.g., an iPod, MP3 player, etc.) 145, a game console (e.g., an Xbox or PS3 console) 146, and/or other types of consumer electronic devices 147. Additionally, a user platform 140 of an example embodiment may include a client personal computer (PC) 148 and a network access system or device 149, such as a modem, wireless access point, network router, or the like. Some consumer electronic devices may enable access to the Internet by being coupled to the computer 148, e.g., a personal computer (PC) such as a laptop or a desktop computer, etc. Some consumer electronic devices may enable access to the Internet by being coupled to the network access system or device 149 directly without connection through a computer. Thus, the user platform 140 provides a means for user behavior data and user feedback to be communicated to the host 110 via the network 125.

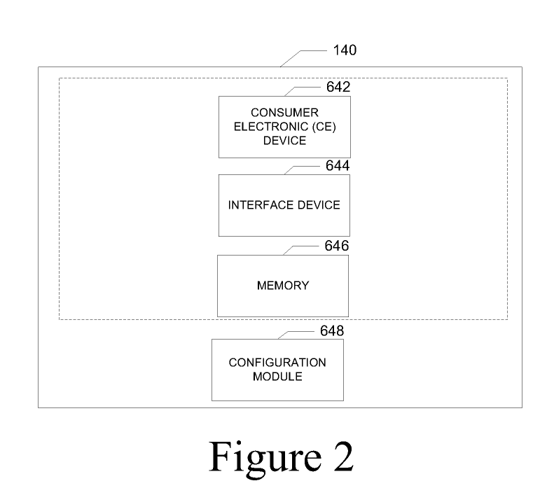

Preferably, the user and the corresponding user platform 140 are registered with the host 110. As shown in FIG. 1, a host 110 can receive user behavior and feedback data from a user platform 140. If the host 110 determines that the user is not a registered user, the host 110 may cause a provision module of the host 110 to automatically register the user with the host 110. With regard to registration of the user platform 140, the first time that a non-registered user platform 140 device is used, e.g., a consumer electronic (CE) device 150, the user may send a registration request to the host 110. In another embodiment, a provision module of host 110 may automatically register the non-registered user platform 140 when the user platform 140 is coupled with the host 110 via a wide-area data network 125 for the first time. In one embodiment, for example, the provision module can provide the user with a registration code for the user platform 140. The user provides the registration code when the user explicitly registers the user platform 140 or refers to the user platform 140 in communications with the host 110. The user platform 140 of some embodiments is further described below with respect to FIG. 2.

As mentioned above, the user platform 140 is preferably registered. The user platform registration or “device registration” operates alternatively, or in conjunction with, the “user registration” of some embodiments. User registration is used to identify and/or authorize a particular individual person for service by a host via a user platform 140. User platform registration is used to identify and/or authorize a particular device or interface for service by the host 110. Either or both types of registration can be used in various embodiments. User registration and user platform registration enable an embodiment to correlate the activity by a particular user on a particular user platform over time and in relation to a community of other users on different user platforms.

FIG. 2 illustrates an example user platform 140, which may correspond to the user platform 140 shown in FIG. 1. The user platform 140 preferably comprises a first consumer electronic (CE) device 642, such as the CE devices 150 of FIG. 1, an interface device 644, a memory 646 and a configuration module 648. The memory 646 and/or the interface device 644 may be preconfigured within any of the CE devices 150. Alternatively, the memory 646 and/or the interface device 644 are added along with the configuration module 648 to form a non-registered user platform 140 that is enabled for registration. For example, the memory 646 and/or the interface device 644 may optionally be coupled internally or externally to any of the CE devices 150.

As mentioned above, some user platforms 140 are initially not registered and require registration for operation with the host 110. In these cases, the first time that a user activates a non-registered user platform 140, the interface device 644 preferably communicates, via the wide-area data network 125, with the host 110. Once the non-registered user platform 140 communicates with the host 110, the configuration module 648 may work with a provision module of host 110 to register the non-registered user platform 140 with the host 110. When the registration is complete, the configuration module 648 may receive a registration code from the provision module. The configuration module 648 may then save the registration code in the memory 646 on the user platform 140. Once registered, the user platform 140 is ready to perform the functionalities described herein with respect to a registered user platform.

The interface device 644 may include hardware and/or software and may also provide various user interfaces to display a variety of information to the user. In an embodiment, the interface device 644 may receive the user interfaces from the host 110. The user interfaces, for example, may be used to display a collection of help information or CE device specification data available from the host 110. The user interfaces, for example, may also be used to display user survey data, prompts for user feedback, and/or community related information, such as bulletin board information, focus group queries or analysis, product reviews, blogs, and the like. The user interfaces may also provide for the user one or more search boxes to enable the user to search for help information by using keywords, topics, etc. The interface device 644, as mentioned above, may also provide connectivity between the user platform 140 and the host 110, via the wide-area data network 125. Interactions between the user platform 140 and the components of the architectures shown in FIGS. 1 and 2 are discussed in more detail below.

In some embodiments, the user platform 140 is configured to communicate directly with the host 110 via the network 125. Further, CE devices 150 of the user platforms 140 may use local interfaces such as USB or local wireless interfaces such as Bluetooth, 802.11, 802.3, and the like, for direct data communication with the computer 148, which can communicate with the host 110. The user platforms 140 can be used by individuals who can log in to or otherwise gain access to the host 110 via the network 125 and become subscribers or members of a CE Device Support service enabled by the various embodiments described herein. The process for registration and/or activation by subscribers and non-subscribers is described in detail above.

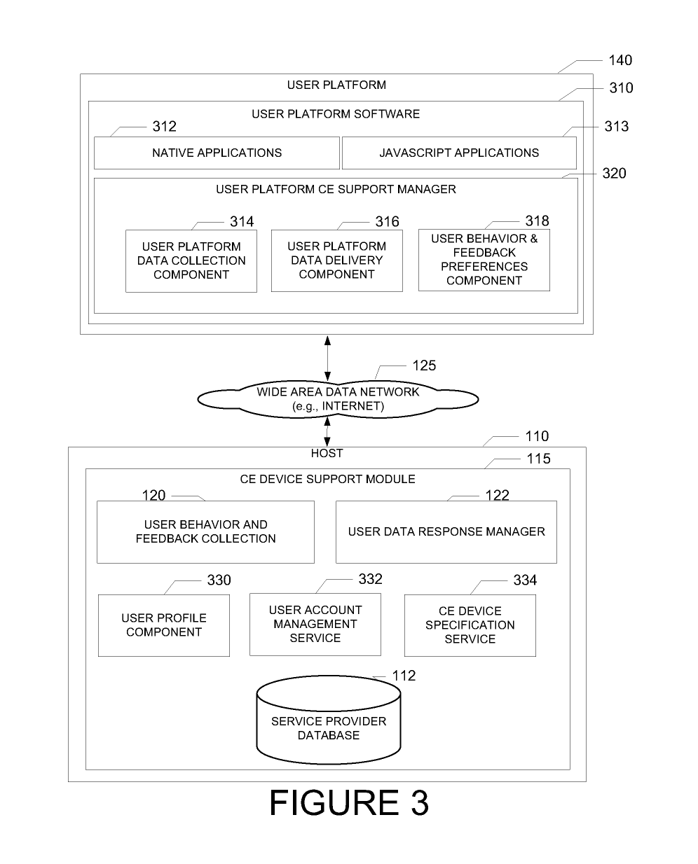

A user platform 140 according to an example embodiment is further described by reference to FIG. 3. As shown in FIG. 3, the user platform 140 of an example embodiment can be configured to include user platform software 310. All or portions of the user platform software 310 can be installed within the user platform 140 firmware or downloaded into the user platform 140 via a network 125. All or portions of the user platform software 310 can be installed within one or more of the devices 141 through 149 of the user platform 140. The user platform software 310 can include native applications 312 and/or Javascript applications 313, which perform standard functions on conventional user platforms 140. Additionally, the user platform software 310 may be configured to include a user platform data collection component 314, a user platform data delivery component 316, and a user behavior and feedback preferences component 318. Each of these components of an example embodiment can be installed within the user platform software 310. The user platform data collection component 314 of an example embodiment coordinates the collection of user behavior and feedback information on the user platform 140. In regard to the collection of user behavior data, the user platform data collection component 314 gathers user input events including, keystrokes, views, clicks, remote control device button activations, CE device front panel button activations, menu selections, page views, mouse click events, mouseover events, webpage access and/or view events, content access and/or view events, object selection events, purchase or bid events, and the like. These user input events and the related data can be captured and retained at the user platform 140 by the user platform data collection component 314 of an example embodiment. Additionally, the user platform data collection component 314 can gather user feedback data from a user. The user feedback data including, for example, user responses to technical questions asked by a technician, responses to requests for feedback, responses to user surveys, and the like. Moreover, the user platform data collection component 314 can gather user platform system data, such as the time of a user input event, the CE device active at the time of the event, the function or command active at the time of the event, any system faults or errors existing at the time of the event, etc. This user behavior data, user feedback data, and user platform system data can be gathered by the user platform data collection component 314 and stored locally on the user platform 140, until the user platform data delivery component 316 is able to transfer the data to the host 110 via the network 125.

The user platform data delivery component 316 is responsible for delivering the user behavior data, user feedback data, and user platform system data to the host 110. The data can be delivered at pre-configured intervals or continuously as configured by a system administrator. The user platform data delivery component 316 tries to provide the host 110 with up-to-date user platform data without exceeding the bandwidth available on the network 125.

A user behavior and feedback preferences component 318 is provided in an example embodiment. The user behavior and feedback preferences component 318 enables a user of user platform 140 to configure the operation of the CE device support service of an embodiment. For example, the user can configure the types of user behavior events captured by the user platform data collection component 314. The user also can configure the interval and/or rate at which the user behavior data, user feedback data, and user platform system data is delivered to the host 110. It will be apparent to those of ordinary skill in the art that a variety of other operational parameters can similarly be configured by using the user behavior and feedback preferences component 318 of an example embodiment. The user configuration information can be retained by the user behavior and feedback preferences component 318 on user platform 140. The user configuration information can also be transferred to the host 110 and retained in a user profile component 330 and/or a user account management service component 332.

Referring still to FIG. 3, the CE device support module 115 of host 110 includes the user behavior and feedback collection module 120 and the user data response manager 122 as described above. The user behavior and feedback collection module 120 gathers and stores the user behavior data, user feedback data, and user platform system data on host 110 as provided by the user platform data delivery component 316. The user data response manager 122 of the host 110 handles the processing of the user behavior data, user feedback data, and user platform system data collected by the user behavior and feedback collection module 120. In general, the user data response manager 122 can analyze the user behavior data to determine if the user behavior with regard to a particular CE device is consistent with appropriate or normal use of the CE device. The user data response manager 122 can access CE device specifications related to the particular CE device being operated by the user on the user platform 140. The CE device specifications can be obtained via the CE device specification service 334. The CE device specifications can inform the user data response manager 122 of the nominal operational flow for a user operating the particular CE device. If the user of the CE device on user platform 140 deviates from this nominal operational flow, the user data response manager 122 can perform at least two processes in response: 1) the user data response manager 122 can activate a user interface on the user platform 140 to offer the user assistance in operating, programming, or installing the CE device for which an operational deviation was detected. This user assistance can be offered as an informational help message or an automatic activation of the feature or command the user was attempting to activate; and 2) the user data response manager 122 can record the user's operational deviation as a design hint related to a potential design change corresponding to the particular CE device. These design hints can be collected and conveyed to a CE device design team, which can use the real-time design hint information to improve the design of the CE device. The design improvements can be integrated into future releases of the particular CE device, thus increasing the likelihood that similar user operational deviations will not occur in future releases of the CE device. These design hints can also be used as information presented to a focus group that can analyze the user behavior and determine if CE device design changes are necessary.

In addition to the real-time user behavior data indicative of the user's operational deviations, the user data response manager 122 can also record user feedback data related to the user's experience with the particular CE device. The user feedback data can be augmented with user survey data, consumer reviews, blogs, bulletin board information, focus group analysis, and the like, that provides information on the particular CE device being analyzed. This augmented feedback data can also be collected and conveyed to a CE device design team, which can use the user feedback information to improve the design of the CE device. Again, the design improvements can be integrated into future releases of the particular CE device, thus increasing the likelihood that timely user feedback will improve the user experience in future releases of the CE device.

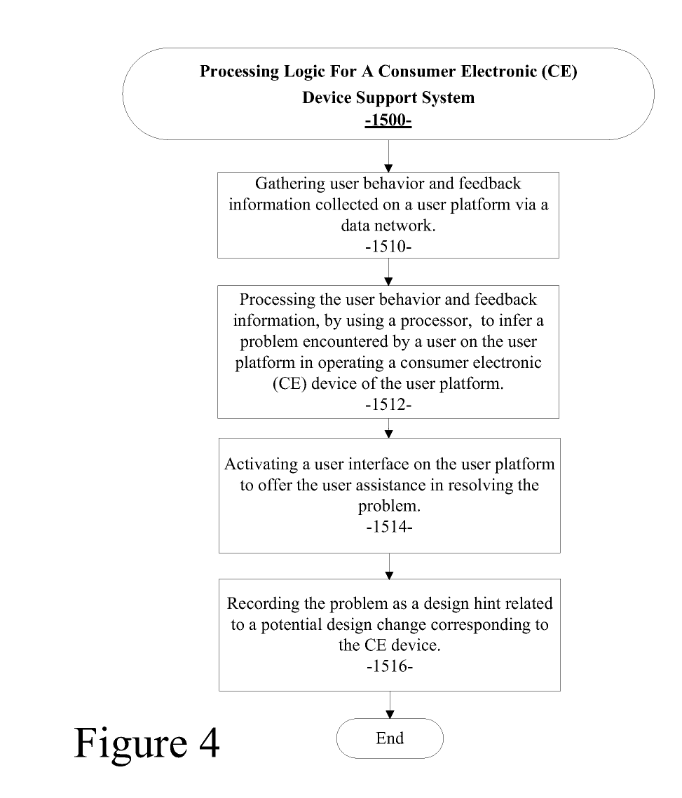

FIG. 4 illustrates a sequence of processing operations in an example embodiment. As shown in FIG. 4, the processing operations performed by an example embodiment 1500 include: gathering user behavior and feedback information collected on a user platform via a data network, at processing block 1510; processing the user behavior and feedback information, by using a processor, to infer a problem encountered by a user on the user platform in operating a consumer electronic (CE) device of the user platform, at processing block 1512; activating a user interface on the user platform to offer the user assistance in resolving the problem, at processing block 1514; and recording the problem as a design hint related to a potential design change corresponding to the CE device, at processing block 1516.

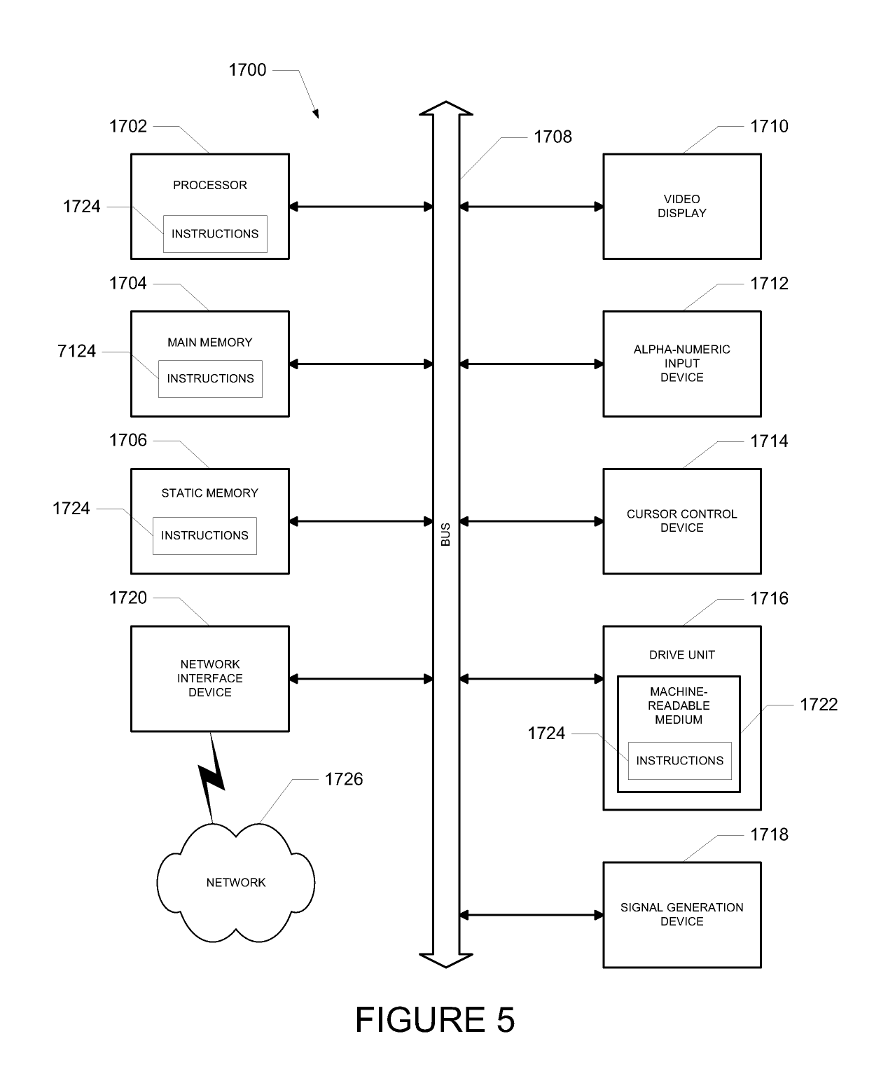

FIG. 5 shows a diagrammatic representation of a machine in the example form of a computer system 1700 within which a set of instructions, for causing the machine to perform any one or more of the methodologies discussed herein, may be executed. In alternative embodiments, the machine operates as a standalone device or may be coupled, e.g., networked, to other machines. In a networked deployment, the machine may operate in the capacity of a server or a client machine in client-server network environment, or as a peer machine in a peer-to-peer and/or distributed network environment. The machine may be a server computer, a client computer, a personal computer (PC), a tablet PC, a set-top box (STB), a Personal Digital Assistant (PDA), a cellular telephone, a web appliance, an audio or video player, a network router, switch or bridge, or any machine capable of executing a set of instructions, sequential or otherwise, that specify actions to be taken by that machine. Further, while a single machine is illustrated, the term “machine” shall also be taken to include any collection of machines that individually or jointly execute a set, or multiple sets, of instructions to perform any one or more of the methodologies discussed herein.

The example computer system 1700 includes a data processor 1702, e.g., a central processing unit (CPU), a graphics processing unit (GPU), or both, a main memory 1704 and a static memory 1706, which communicate with each other via a bus 1708. The computer system 1700 may further include a video display unit 1710, e.g., a liquid crystal display (LCD), a cathode ray tube (CRT), or other imaging technology. The computer system 1700 also includes an input device 1712, e.g., a keyboard, a cursor control device 1714, e.g., a mouse, a disk drive unit 1716, a signal generation device 1718, e.g., a speaker, and a network interface device 1720.

The disk drive unit 1716 includes a machine-readable medium 1722 on which is stored one or more sets of instructions, e.g., software 1724, embodying any one or more of the methodologies or functions described herein. The instructions 1724 may also reside, completely or at least partially, within the main memory 1704, the static memory 1706, and/or within the processor 1702 during execution thereof by the computer system 1700. The main memory 1704 and the processor 1702 also may constitute machine-readable media. The instructions 1724 may further be transmitted or received over a network 1726 via the network interface device 1720.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations. In example embodiments, a computer system, e.g., a standalone, client or server computer system, configured by an application may constitute a “module” that is configured and operates to perform certain operations as described herein. In other embodiments, the “module” may be implemented mechanically or electronically. For example, a module may comprise dedicated circuitry or logic that is permanently configured, e.g., within a special-purpose processor, to perform certain operations. A module may also comprise programmable logic or circuitry, e.g., as encompassed within a general-purpose processor or other programmable processor, that is temporarily configured by software to perform certain operations. It will be appreciated that the decision to implement a module mechanically, in the dedicated and permanently configured circuitry, or in temporarily configured circuitry, e.g. configured by software, may be driven by cost and time considerations. Accordingly, the term “module” should be understood to encompass an entity that is physically or logically constructed, permanently configured, e.g., hardwired, or temporarily configured, e.g., programmed, to operate in a certain manner and/or to perform certain operations described herein. While the machine-readable medium 1722 is shown in an example embodiment to be a single medium, the term “machine-readable medium” should be taken to include a single non-transitory medium or multiple non-transitory media, e.g., a centralized or distributed database, and/or associated caches and servers that store the one or more sets of instructions. The term “machine-readable medium” shall also be taken to include any non-transitory medium that is capable of storing, encoding or carrying a set of instructions for execution by the machine and that cause the machine to perform any one or more of the methodologies of the present description. The term “machine-readable medium” shall accordingly be taken to include, but not be limited to, solid-state memories, optical media, and/or magnetic media. As noted, the software may be transmitted over a network via a transmission medium. The term “transmission medium” shall be taken to include any non-transitory medium that is capable of storing, encoding or carrying instructions for transmission to and execution by the machine, and includes digital or analog communications signal or other intangible medium to facilitate transmission and communication of such software.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of ordinary skill in the art upon reviewing the above description. Other embodiments may be utilized and derived therefrom, such that structural and logical substitutions and changes may be made without departing from the scope of this disclosure. The figures provided herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to comply with 37 C.F.R. §1.74(b) to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

The system of an example embodiment may include software, information processing hardware, and various processing steps, which are described herein. The features and process steps of example embodiments may be embodied in articles of manufacture as machine or computer executable instructions. The instructions can be used to cause a general purpose or special purpose processor, which is programmed with the instructions to perform the steps of an example embodiment. Alternatively, the features or steps may be performed by specific hardware components that contain hard-wired logic for performing the steps, or by any combination of programmed computer components and custom hardware components. While embodiments are described with reference to the Internet, the method and system described herein is equally applicable to other network infrastructures or other data communications systems.

Various embodiments are described herein. In particular, the use of embodiments with various types and formats of user interface presentations and/or application programming interfaces may be described. It can be apparent to those of ordinary skill in the art that alternative embodiments of the implementations described herein can be employed and still fall within the scope of the claimed invention. In the detail herein, various embodiments are described as implemented in computer-implemented processing logic denoted sometimes herein as the “Software”. As described above, however, the claimed invention is not limited to a purely software implementation.

Thus, a computer-implemented method, system, and apparatus for providing networked assistance and feedback control for consumer electronic devices are disclosed. While the present invention has been described in terms of several example embodiments, those of ordinary skill in the art can recognize that the present invention is not limited to the embodiments described, but can be practiced with modification and alteration within the spirit and scope of the appended claims. The description herein is thus to be regarded as illustrative instead of limiting.

What is claimed is:

1. A computer-implemented method comprising:
gathering user behavior and feedback information collected on a user platform via a data network;
processing the user behavior and feedback information, by using a processor, to infer a problem encountered by a user on the user platform in operating a consumer electronic (CE) device of the user platform;
activating a user interface on the user platform to offer the user assistance in resolving the problem; and
recording the problem as a design hint related to a potential design change corresponding to the CE device.

2. The computer-implemented method of claim 1 including gathering user platform system data collected on the user platform.

3. The computer-implemented method of claim 1 wherein the user behavior information can include at least one from the group: CE device remote control button activations, CE device menu selections, mouse click events, mouseover events, webpage access and/or view events, content access and/or view events, object selection events, purchase events, and bid events.

4. The computer-implemented method of claim 1 wherein the user feedback information can include at least one from the group: user responses to technical questions asked by a technician, user responses to requests for feedback, user responses to surveys, and analysis provided by a focus group.

5. The computer-implemented method of claim 1 wherein inferring a problem encountered by a user on the user platform in operating a consumer electronic (CE) device includes comparing the user behavior information with CE device specifications related to the CE device being operated by the user on the user platform.

6. The computer-implemented method of claim 1 wherein the design hint is conveyed to a design team associated with the CE device.

7. The computer-implemented method of claim 1 including using the design hint to modify a design of the consumer electronic (CE) device of the user platform.

8. The computer-implemented method of claim 1 wherein the design hint is conveyed to a focus group.

9. A system comprising:
one or more data processors;
a data network interface in communication with the one or more data processors;
a database for storing processed information and accessible to the one or more data processors;
a consumer electronic (CE) device support component being executable by the one or more data processors to:
gather user behavior and feedback information collected on a user platform via a data network;
process the user behavior and feedback information to infer a problem encountered by a user on the user platform in operating a consumer electronic (CE) device of the user platform;
activate a user interface on the user platform to offer the user assistance in resolving the problem; and
record the problem as a design hint related to a potential design change corresponding to the CE device.

10. The system of claim 9 being further configured to gather user platform system data collected on the user platform.

11. The system of claim 9 wherein the user behavior information can include at least one from the group: CE device remote control button activations, CE device menu selections, mouse click events, mouseover events, webpage access and/or view events, content access and/or view events, object selection events, purchase events, and bid events.

12. The system of claim 9 wherein the user feedback information can include at least one from the group: user responses to technical questions asked by a technician, user responses to requests for feedback, user responses to surveys, and analysis provided by a focus group.

13. The system of claim 9 wherein inferring a problem encountered by a user on the user platform in operating a consumer electronic (CE) device includes comparing the user behavior information with CE device specifications related to the CE device being operated by the user on the user platform.

14. The system of claim 9 wherein the design hint is conveyed to a design team associated with the CE device.

15. The system of claim 9 being further configured to use the design hint to modify a design of the consumer electronic (CE) device of the user platform.

16. The system of claim 9 wherein the design hint is conveyed to a focus group.

17. An article of manufacture comprising a non-transitory machine-readable storage medium having machine executable instructions embedded thereon, which when executed by a machine, cause the machine to:
gather user behavior and feedback information collected on a user platform via a data network;
process the user behavior and feedback information to infer a problem encountered by a user on the user platform in operating a consumer electronic (CE) device of the user platform;
activate a user interface on the user platform to offer the user assistance in resolving the problem; and
record the problem as a design hint related to a potential design change corresponding to the CE device.

18. The article of manufacture of claim 17 being further configured to gather user platform system data collected on the user platform.

19. A user platform with a data network interface, the user platform comprising:
a processor;
a user behavior information and user feedback information storage device; and
a user platform consumer electronic (CE) device support manager being executable by the processor to:
gather user behavior and feedback information collected on the user platform;
transfer the user behavior and feedback information to a host server via the data network interface; and
activate a user interface on the user platform to offer a user assistance in resolving a problem identified by the host server.

20. The user platform of claim 19 being further configured to gather user platform system data collected on the user platform.
